(19) United States
(12) Patent Application Publication
(10) Pub. No.: US 2025/0233140 A1
(43) Pub. Date: Jul. 17, 2025

(54) A DOPED TITANIUM NIOBIUM-OXIDE LITHIUM-ION BATTERY ANODE WITH IMPROVED RATE CAPABILITY

(71) Applicant: Georgia Tech Research Corporation, Atlanta, GA (US)

(72) Inventors: Luke P. Soule, Atlanta, GA (US); Meilin Liu, Atlanta, GA (US)

(21) Appl. No.: 18/722,424

(22) PCT Filed: Jan. 18, 2023
(86) PCT No.: PCT/US2023/011004

§ 371 Date: Jun. 20, 2024

Related U.S. Application Data
(60) Provisional application No. 63/300,446, filed on Jan. 18, 2022.

(51) Int. Cl. H01M 4/485; C01G 33/00; H01M 4/02; H01M 4/131; H01M 4/66; H01M 10/0525

(52) U.S. Cl. CPC H01M 4/485; C01G 33/00; H01M 4/131; H01M 4/661; H01M 10/0525; C01P 2004/04; C01P 2004/62; C01P 2004/64; C01P 2004/80; C01P 2006/40; H01M 2004/028

(57) ABSTRACT

To make an electrode material (312). Nb₂O₅ powder (110) is milled (112) to generate Nb₂O₅ nanoparticles. An oxidant is added to the Nb₂O₅ nanoparticles to form oxidant coated Nb₂O₅ nanoparticles (114). The oxidant coated Nb₂O₅ nanoparticles is sealed with a carbon compound that releases a carbon compound vapor, which polymerizes on the Nb₂O₅ nanoparticles, which agglomerate to form polymerized Nb₂O₅ nanoparticles (116). The polymerized Nb₂O₅ nanoparticles are calcinated to form a hierarchical N-rich carbon conductive electrode layer (118). An electrode (302) that includes a Ti₂Nb₁₀O₂₉@NC (312) layer is applied to a conductive substrate (310). A battery (300) includes an anode (314), a cathode (302) and an electrolyte (318) between the anode and the cathode (302). The cathode (302) includes a Ti₂Nb₁₀0₂₉@NC@NC layer (312).

### CROSS-REFERENCE TO RELATED APPLICATION(S)

This application claims the benefit of U.S. Provisional Patent Application Ser. No. 63/300,446, filed Jan. 18, 2022, the entirety of which is hereby incorporated herein by reference.

### BACKGROUND OF THE INVENTION

### 1. Field of the Invention

The present invention relates to electrodes and, more specifically, to TiₓNb_{y}O_{z} electrodes.

### 2. Description of the Related Art

One of the primary barriers to wide-spread electric vehicle adoption is the slow charging speeds required to drive a reasonable distance (200 miles or more). The U.S. Department of Energy (DOE) outlines a fast charging goal of 15 minutes charge to 80% of pack capacity, which is currently out of reach for commercial battery technology. While some hybrid technologies based on metal ion-capacitors show promise to achieve reasonable charge/discharge rates while maintaining suitable energy densities, further improvements in all aspects of battery design are needed to create fast-charging batteries.

For fast-charging applications, TiₓNb_{y}O_{z} oxides, such as TiNb₂₄O₆₂, Ti₂Nb₁₀O₂₉, TiNb₂O₆, and TiNb2O₇ are promising anode materials for long-life and high-rate lithium ion battery (LIB) and hybrid lithium ion capacitor (LIC) systems. The crystal structure of TiₓNb_{y}O_{z} oxides are of the same structure family as H-Nb₂O₅, which can be described as a defective ReO₃-like structure where crystallographic shear planes cut the structure into blocks, typically 3-4 octahedra long in length and width. While initial papers claimed that Ti₄⁺ randomly substitutes for Nb₅⁺ in octahedral, neutron scattering experiments have revealed that Ti₄⁺ selectively occupies corner and edge sites of the blocks rather than randomly through the structure. The nature of the fast ionic conductivity of the material as well as the lithiation mechanism of the oxide is an active topic of research, with some papers putting forth a reversible “single-phase↔two-phase↔single-phase” reaction pathway during the batteries charge-discharge processes. Li₄Ti₅O₁₂ (LTO) is currently regarded as a state-of-the-art material for high power LIB anodes, but TiₓNb_{y}O_{z} compounds can store substantially more lithium ions at low and high rates than this compound. Additionally, compared with very flat voltage plateau of LTO, TiₓNb_{y}O_{z} compounds typically display a predictable sloping behavior at the end of a charge/discharge cycle, making the prediction of cycle termination straightforward.

Even though TiₓNb_{y}O_{z} compounds show notable rate-capability, they can be limited by their low electronic conductivity (<10-9 S cm-1), which is attributed to empty 3d/4d orbitals in the Ti/Nb metal d-band. To overcome the poor electrical conductivity of the material, two strategies have been widely used, including carbon coating, and nanostructuring. While these strategies have greatly enhanced the rate performance of TiₓNb_{y}O_{z} composite electrodes, there are sacrifices that must be made. Due to the inherently low density of carbon, techniques that use the material to compensate for poor electronic conductivity of active materials will decrease the packing efficiency of the electrode material and result in inherently low volumetric capacities. This is in addition to the 10-20% carbon that is already used to make typical battery electrodes. For nanostructured material, such as nanofibers, nanotubes, and three dimensional aerogels, geometric constraints and high surface energies prevent efficient packing of active material and further decrease the overall volumetric capacity of the electrode. In addition to these issues, processing of nanomaterials is often costly, needs to utilize non-aqueous medium and special equipment, and is usually difficult to scale to industrial levels. Solid state synthesis is common used for large-scale production of phase-pure TiₓNb_{y}O_{z} oxides with oxide precursors and firing temperature up to 1000° C. At these calcination temperatures, the synthesized powder has particle sizes that vary between 20 and 50 μm. Currently, the rate or power capability of TNO-based systems is limited by the poor electronic conductivity of the material. While solid state synthesis is an important route to achieve efficient packing of active material, the problem of insufficient electronic conductivity still needs to be addressed.

Therefore, there is a need for TiₓNb_{y}O_{z} electrodes with higher electronic conductivity.

### SUMMARY OF THE INVENTION

The disadvantages of the prior art are overcome by the present invention which, in one aspect, is a method of making an electrode material, in which Nb₂O₅ powder milled to generate Nb₂O₅ nanoparticles of a first particle size. An oxidant is added to the Nb₂O₅ nanoparticles to form oxidant coated Nb₂O₅ nanoparticles. The oxidant coated Nb₂O₅ nanoparticles is placed in a container with a carbon compound that releases a carbon compound vapor. T the container is sealed so that the oxidant causes the carbon compound vapor to polymerize on the Nb₂O₅ nanoparticles and so that the Nb₂O₅ nanoparticles agglomerate to form polymerized Nb₂O₅ nanoparticles of a second particle size. The polymerized Nb₂O₅ nanoparticles are calcinated at a predetermined temperature so as to form a hierarchical N-rich carbon conductive electrode layer.

In another aspect, the invention is an electrode that includes a conductive substrate and a Ti₂Nb₁₀O₂₉@NC layer applied thereto.

In yet another aspect, the invention is a battery that includes an anode, a cathode and an electrolyte. The cathode includes a Ti₂Nb₁₀O₂₉@NC layer. The electrolyte is disposed between the anode and the cathode.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 includes a series of schematic diagrams illustrating one embodiment of a synthetic route for TNO@NC composites and corresponding TEM images of: bulk Nb₂O₅ raw material, ball milled Nb₂O₅, polypyrrole (PPy) coated Nb₂O₅ and TNO@NC.

FIG. 2 includes; a TEM image TNO@NC composite; an HRTEM image of TNO@NC composite, a HRTEM lattice image thereof; a corresponding EDS mapping thereof; and micrographs of: C, N, Ti, Nb and O in a TNO@NC composite.

FIG. 3 includes a schematic diagram of an electrode employing an NTO material.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

The inventors have found that Ti₂Nb₁₀O₂₉ (TNO) is a suitable electrode for high-performance lithium-ion batteries and capacitors because of its large lithium storage capacity and high Li⁺ diffusivity. In one embodiment, the invention includes a hierarchical N-rich carbon conductive layer wrapped TNO structure (TNO@NC) using a polypyrrole-chemical vapor deposition (PPy-CVD) process. It was found that carbon coating with PPy-carbon partially reduces Ti and Nb cations, forms TiN, and creates oxygen vacancies in the TNO@NC structure that further increase overall electronic and ionic conductivity. Various defect models and density functional theory (DFT) calculations have been used by the inventors to show how oxygen vacancies influence the electronic structure and Li-ion diffusion energy of the TNO@NC composite. The optimized TNO@NC sample shows notable rate capability in half-cells with a reversible capacity of 300 mAh g⁻¹ at 1 C rate and maintains 211 mAh g⁻¹ at a rate of 100 C, which is superior to that of most MxNbyOz materials. Full cell LiNi_{0.5}Mn_{1.5}O₄ (LNMO)∥TNO@NC lithium-ion batteries (LIB) and active carbon (AC)∥TNO@NC hybrid lithium-ion capacitors (LIC) exhibited notable volumetric and gravimetric energy and power densities.

One representative embodiment employs a ball-milling and a polypyrrole (PPy)-chemical vapor deposition (CVD) solid-state synthesis method to coat Ti₂Nb₁₀O₂₉ (TNO) nanoparticles with a thin layer of nitrogen-doped PPy-carbon that does not significantly decrease the tap-density of the material. The composite allows for sufficient electrical conductivity and acceptable volumetric capacity. The prepared TNO@NC architecture can be described by agglomerated secondary particles (200-800 nm) which are composed of smaller nanoparticles (˜40 nm). This architecture allows for short Li⁺ diffusion paths between nanoparticles and a high packing density afforded by large secondary particles. In addition to highly conductive N-doped carbon thin-films coated on the particles, XPS shows that Ti4⁺ and Nb5⁺ ions are partially reduced and that conductive Ti-N is formed in situ during the carbon thermal calcination process. EPR results further confirm the existence of oxygen vacancies in the TNO@NC structure, and DFT calculations demonstrate that oxygen vacancies improve both the electronic and ionic conductivities of the TNO@NC materials. The hierarchical structure of the electrode allows for fast lithium insertion/extraction kinetics as well as considerable packing density, resulting in the fabrication of a full cell LIB and LIC that shows promising gravimetric and volumetric power and energy density.

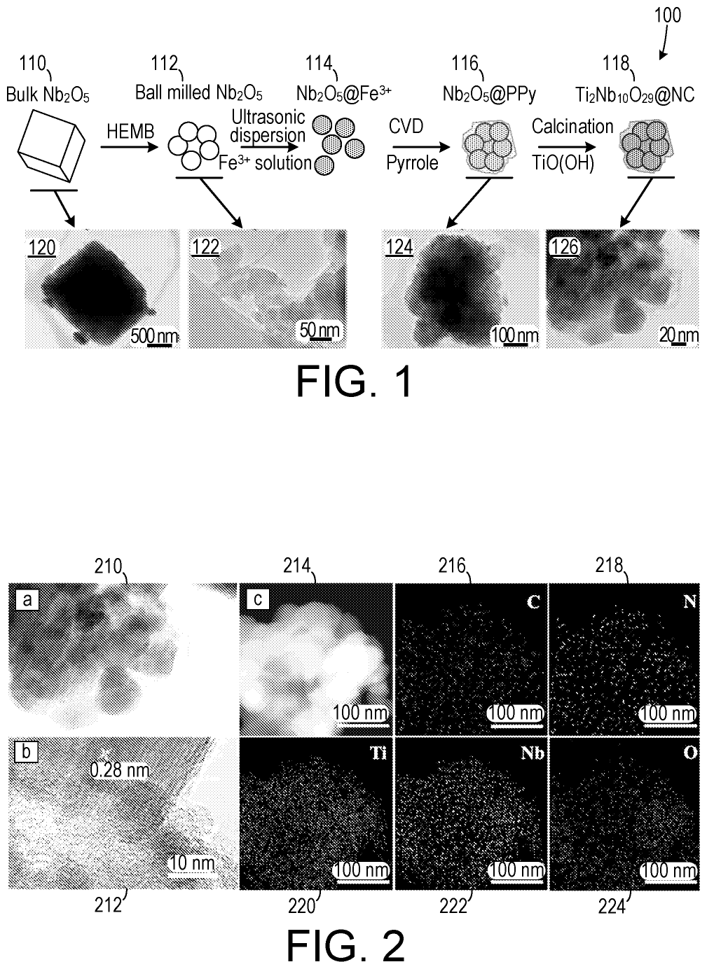

As shown in FIG. 1, in one embodiment, bulk Nb₂O₅ 110 powder 120 is added to a high energy ball milling device and milled 112 to a unit size of about 50 nm 122, an ultrasonically dispersed Fe³⁺ solution is added to the ball milled particles, rendering Nb₂O₅@Fe³⁺. Pyrrole is added through chemical vapor deposition 116 to form agglomerated Nb₂O₅@PPy particles 124. These particles 124 are then calcinated with TiO9OH) 118 so as to become Ti₂Nb₁₀O₂₉@NC particles 126 (i.e., TNO@NC composite particles).

Several micrographs, as show in FIG. 2, include TEM images and the corresponding elemental distribution of the TNO@NC composite. The material 210 shows particle sizes around 40 nm and is encapsulated by a continuous carbon layer with a thickness of ˜1-4 nm. The carbon content in the composite was ˜1.8 wt. % by TGA analysis. Two d-spacing values of 0.35 and 0.28 nm were measured in HRTEM lattice image 212, which are in good agreement with the d-spacing of the (400) and (215 s̅) planes for monoclinic TNO, respectively. The EDS result 214 verifies the homogenous coating of the particles by PPy derived carbon, and that the film contains a large amount of nitrogen. Also shown are EDS mappings of: C 216, N 218, Ti 220, Nb 222 and O 224 in a TNO@NC composite. Some have proposed in literatures that N-doping alters the surface electron density of oxide materials and in-turn enhances the ion and electron transfer kinetics.

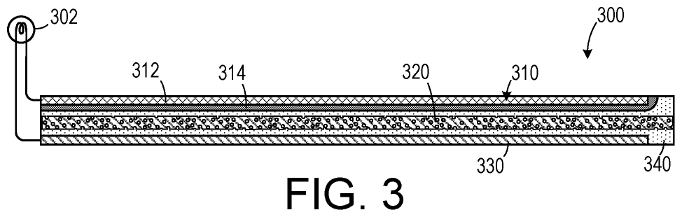

A schematic TNO-based battery 300 for powering a load 302 is shown in FIG. 3, which includes an anode 330, a cathode 310, a porous separator 320 and an electrolyte 340 that is in electrical communication with both the anode 330 and the cathode 310 through the separator 320. The cathode 310 includes a conductive substrate 312, such as copper foil, to which a layer of NTO 314 is applied.

In one experimental embodiment, the TNO@NC composite was synthesized by a PPy-CVD assisted solid-state reaction process. Briefly, 5 g of Nb₂O₅ powder (available from Aladdin Reagent Co. Ltd., AR, 99.9%) was ball milled in deionized (DI) water using a Pulverisette-6 planetary mill with 80 ml grinding bowls (available from Fritsch Co.) at a rotational speed of 500 rpm for 4 hours. After ball milling, the dried material was dispersed in 10 g of 20 wt. % Fe (III) p-toluene sulfonate (available from Sigma-Aldrich) n-butanol solution to cover the surface of the Nb₂O₅ particles with Fe₃⁺ ions, which act to polymerize the pyrrole monomer to polypyrrole on the surface of particles. Then, the mixture was transferred into a sealed container with 1 ml of pyrrole that released pyrrole monomer vapor at room temperature, which interacted with the Fe^{3 +} ions on the surface of the particles to polymerize to polypyrrole. After 45 min., the powder was taken out of the container and centrifuged with ethanol several times to remove any Fe^{3+/2+} salts and residual pyrrole monomers. The sample at this stage will be denoted as Nb₂O₅@PPy. Nb₂O₅@PPy was hand-ground with a stoichiometric amount of metatitanic acid [TiO(OH)₂] (available from Jinjinle Chemical Co. Ltd., CP, 99%) for 1 hour. The resulting powder was calcined at various temperatures between 600 and 1000° C. for 20 hours under a nitrogen atmosphere. As a control sample, Ti₂Nb₁₀O₂₉was prepared via solid-state reaction with Nb₂O₅ powder and anatase TiO₂ (available from Aladdin Reagent Co. Ltd., 99.8%, primary particle size: 30 nm) as the niobium and titanium source, respectively. The initial reagents were hand-ground for 1 h and fired in air between 800 and 1100° C. for 20 hours.

The morphology of the synthesized material was observed using an ultrahigh-resolution field-emission scanning electron microscope (FE-SEM) (INCA X-Max 80, Oxford Instruments) and a transmission electron microscope (TEM) (JEM-2100F, JEOL, Ltd., Japan). X-ray diffraction (XRD) patterns were recorded on a Rigaku D/MAX-2200/PC X-ray diffractometer at 40 kV and 20 mA, with a Cu Ka radiation in the 2-theta range from 10-70o. The amount of carbon contributed by the PPy layer in the Nb2O5@PPy and TNO@NC composite was determined by thermogravimetric analysis (TGA) using a Netzsch STA 449 F1 with a heating rate of 10° C. min⁻¹ in an air atmosphere. Porosity and Brunauer-Emmett-Teller (BET) surface areas for the samples were measured using a nitrogen sorption instrument (Micromeritics, ASAP2020). The surface elements and corresponding valence states of the samples were analyzed using an XPS (Kratos Axis Ultra DLD). EPR spectra of the pristine TNO and TNO@NC samples were acquired using an EPR spectrometer (Bruker A320) at room temperature. The tap densities were measured according to the ASTM international standard B527-15, modified to accommodate a 5-10 cm³ graduated cylinder with the rate of ˜200 taps per minute. The electrical conductivity of the obtained TNO@NC material was measured by a four-point probe method (RTS-9) at room temperature. The samples for the electrical conductivity measurement were prepared by pressing the TNO@NC powders into a pellet (10 mm in diameter and 1 mm in thickness) under a pressure of 20 MPa.

Electrode fabrication: For half-cell tests of the TNO@NC, 2032-type coin cells were used. The active electrodes were prepared using a slurry containing 85 wt % active material, 8 wt % carbon black, and 7 wt % polyvinylidene fluoride (PVDF) in N-methyl-2-pyrrolidone (NMP). The slurry was coated on a copper foil current collector. The mass loading of active material was approximately 1.4 mg cm⁻², and the electrochemical performances using higher mass loading of 3.3 mg cm⁻² and 6.7 mg cm⁻² were also studied. The electrodes were punched to a diameter of 1.2 cm and then dried in a vacuum oven at 100° C. for 24 hours before being transferred to a glovebox. The coin cells were assembled in the glovebox with lithium metal as the counter and reference electrodes, a microporous polypropylene Celgard 3501 (available from Celgard, LLC Corp., USA) as a separator, and 1 M LiPF₆/EC/DMC (1:1 by volume ratio) as the electrolyte.

For the full cell tests, the commercial LiNi_{0.5}Mn_{1.5}O₄ (MJS Energy Technology Co., Ltd) and active carbon (AC) (Kuraray Co., Ltd.) were used as the cathode materials for LIB and LIC, respectively. The LiNi_{0.5}Mn_{1.5}O₄ cathode was prepared using a slurry containing 80 wt % LiNi_{0.5}Mn_{1.5}O₄ active material, 10 wt % carbon black, and 10 wt % PVDF in NMP. The active carbon cathode (AC) was prepared using a slurry containing AC, carbon black and carboxymethyl cellulose (CMC) at the weight ratio of 80:10:10 in water. The weight ratios of cathodes to anodes in the LIB and LIC full cells were carefully balanced based on the specific capacity of LiNi_{0.5}Mn_{1.5}O₄ or AC cathodes and TNO@NC anode. The weight ratio of cathode to anode for the LNMO∥TNO@NC LIB is 2.1 and for the AC∥TNO@NC LIC is 6.6, respectively. The current densities and corresponding specific capacities are calculated based on the mass of the anodic active material.

XPS was used to quantify the amount of N in the TNO@NC sample and to probe the valence state of each cation in the pristine TNO and TNO@NC samples. It was found that some of the Ti⁴⁺ and Nb⁵⁺ are reduced, respectively, to Ti³⁺ and Nb⁴⁺ in the TNO@NC composite. Considerable Ti³⁺ (50.7 at. % of Ti atoms) and Nb⁴⁺ (25.9 at. % of Nb atoms) are present on the surface of the TNO@NC sample. This amount of the reduced Ti³⁺ is greater than most reported values, due likely to in situ formation of Ti-N chemical bond, as confirmed by the N1s and C1s high resolution XPS spectra for the TNO@NC sample and the corresponding refinement results. Since the conductivity of TiN is relatively high, the electronic conductivity of TNO@NC composite is enhanced by the presence of TiN. The electrical conductivity of TNO@NC (6.3×10^{31 3} S cm⁻¹, as determined from four-point probe measurement) is about six orders of magnitude higher than that of the pure TNO (10⁻⁹ S cm⁻¹). The O 1s spectra for the pristine TNO and TNO@NC samples showed large peak at ˜529.7 eV that is shifted towards higher binding energy for the TNO@NC sample than the pristine TNO sample, implying some electron drain in the oxide matrix of the TNO@NC sample. This means that some oxygen is missing from the lattice. Also, a strong EPR signal, indicative of the formation of oxygen vacancies at g=2.0, is observed for the TNO@NC sample, but it is missing for the pure TNO sample, confirming the presence of oxygen deficiency in the TNO@NC sample.

The electrochemical performance of TNO@NC was characterized under constant current charge-discharge cycling at 1 C rate between 1.0 and 3.0 V using a half cell consisting of a TNO@NC composite working electrode and a metallic lithium counter/reference electrode. The first discharge capacity was 334 mAh g⁻¹ with an initial Coulombic efficiency of 90.1%. In contrast, when a pristine TNO (obtained from solid-state reaction) is used as the working electrode, the first discharge capacity was 272 mAh g⁻¹ with an initial Coulombic efficiency of 89.7%. The stability both electrodes is shown to be sufficient in following cycles. The inventors have previously demonstrated that the lithiation capacity of carbonized PPy anode is about 110 mAh g⁻¹ at 1 C rate in the potential range of 1-3 V. However, considering the small carbon content in the composite (only ˜1.8 wt. %), the contribution of the coated carbon layer to the sample capacity is assumed to be negligible. While it may be unclear as to the origin of the lower initial Coulombic efficiency, one can speculate that a small amount of residual Li⁺ stays in the structure after lithiation, resulting in a slight structure change. The discharge capacity is larger than that typically reported for TiₓNb_{y}O_{z} compounds, such as TiNb₂₄O₆₂ (210-280 mAh g⁻¹), Ti₂Nb₁₀O₂₉ (238-290 mAh g⁻¹), and TiNb₂O₇ (213251 mAh g⁻¹). A theoretical capacity of Ti₂Nb₁₀O₂₉ should be 396 mAh g⁻¹ if a two-electron transfer per Nb atom (Nb ⁵⁺→Nb³⁺), and one-electron transfer per Ti atom (Ti⁴⁺→Ti³⁺) is assumed. Therefore, the theoretical maximum amount of Li⁺ per transition metal (Nb or Ti) should be 1.83 in the Ti₂Nb₁₀O₂₉ compound. Experimentally, the amounts of reversible inserted Li⁺ per transition metal in the TNO@NC and pristine TNO electrodes at a 1 C rate is 1.39 and 1.13 respectively. This indicates that the TNO@NC composite can insert more Li⁺ than the pristine TNO at the same discharge rate.

The electrochemical performance of TNO@NC was characterized under constant current charge-discharge cycling at 1 C rate between 1.0 and 3.0 V using a half cell consisting of a TNO@NC composite working electrode and a metallic lithium counter/reference electrode. The first discharge capacity was 334 mAh g⁻¹ with an initial Coulombic efficiency of 90.1%. In contrast, when a pristine TNO (obtained from solid-state reaction) is used as the working electrode, the first discharge capacity was 272 mAh g⁻¹ with an initial Coulombic efficiency of 89.7%. The stability both electrodes was shown to be sufficient in following cycles. The inventors have demonstrated that the lithiation capacity of carbonized PPy anode is about 110 mAh g⁻¹ at 1 C rate in the potential range of 1-3 V. However, considering the small carbon content in the composite (only ˜1.8 wt. %), the contribution of the coated carbon layer to the sample capacity was assumed to be negligible. While it may be unclear as to the origin of the lower initial Coulombic efficiency, one can speculate that a small amount of residual Li⁺ stays in the structure after lithiation, resulting in a slight structure change. The discharge capacity is larger than that typically reported for TiₓNb_{y}O_{z} compounds, such as TiNb₂₄O₆₂ (210-280 mAh g⁻¹), Ti₂Nb₁₀O₂₉ (238-290 mAh g⁻¹), and TiNb₂O₇ (213¬251 mAh g⁻¹). A theoretical capacity of Ti₂Nb₁₀O₂₉ should be 396 mAh g⁻¹ if a two-electron transfer per Nb atom (Nb⁵⁺→Nb³⁺), and one-electron transfer per Ti atom (Ti⁴⁺→Ti³⁺) is assumed. Therefore, the theoretical maximum amount of Li⁺ t per transition metal (Nb or Ti) should be 1.83 in the Ti₂Nb₁₀O₂₉ compound. Experimentally, the amounts of reversible inserted Li⁺ per transition metal in the TNO@NC and pristine TNO electrodes at a 1 C rate is 1.39 and 1.13 respectively. This indicates that the TNO@NC composite can insert more Li⁺ than the pristine TNO at the same discharge rate.

Furthermore, the discharge curves can be divided into three regions. In Region I (located at 3-1.7 V) is considered as an initial intercalation process of Li⁺. It is noteworthy that the slope of discharge curve of the TNO@NC anode is gentler than that of pristine TNO sample at ˜1.9 V in Region I. The electrochemical reduction process reflected by this small plateau is still not fully described. Although it is generally believed that this small discharge plateau around 1.9 V can be ascribed to the reduction of Ti4⁺→Ti3⁺. This conclusion is likely not correct because H-Nb₂O₅ also possesses the same charge/discharge plateau at ˜1.9 V and it has been verified that the charge/discharge plateau should correspond to the average redox potential of both Ti and Nb using X-ray absorption near edge spectroscopy. Region II (located at 1.6-1.7 V) exhibit a plateau in the middle of the discharge curves, which corresponds likely to a two-phase coexistence reaction process. In this process, the Li-ions diffuse in the crystal lattice of TNO to keep the lowest energy, and the density of Li⁺ in the crystal lattice increases accordingly. The same situation occurs in the last solid-solution process shown in Region III. The increase in Li per transition metal for TNO@NC compared to the pure TNO material in Region II and III infers that the Li⁺ diffusion rate in the TNO@NC composite is faster than that of the pristine TNO sample. This is in accordance with the DFT calculation results.

A corresponding redox process investigation by CV resulted in three CV curves for TNO@NC electrode. A pair of redox peaks located at 1.64 V (reduction peak) and 1.71 V (oxidation peak) correspond to the voltage plateaus, which are most likely attributed to the Nb⁵⁺/Nb⁴⁺ redox couple. In the difference between the redox peaks is only 0.07 V. Compared to the CV curve of the pristine TNO sample, the potential of the reduction peak of TNO@NC is 35 mV higher than that of the pristine TNO anode, indicates a smaller polarization and better reversibility than the pure sample. A larger rectangle area appeared below 1.6 V that corresponded to electrochemical features of capacitance, which is accompanied by further reduction of Nb⁴⁺ to Nb³⁺. Furthermore, compared with the pristine TNO material, the TNO@NC electrode exhibits a larger rectangular area, implying that a more capacitive intercalation reaction for TNO@NC than that for the pure sample. This capacitive reaction is expected to increase the rate capacity of the TNO@NC anode.

To describe the charge storage kinetics of the TNO@NC and pristine TNO electrodes, the capacitance contribution of the total capacity was calculated according to the CV measurements under various scan rates. Both the TNO@NC and pristine TNO samples possess considerable double-layer capacitive behavior during the charge-discharge process. This is attributed to the typical Roth-Wadsley structure with ordered ReO₃-matrix in TNO, which can provide a tunnel structure for realizing pseudocapacitive behavior accompanied by a faradaic charge transfer process with no crystallographic phase changes. Furthermore, the capacitive contribution of TNO@NC electrode is much more than the pristine TNO electrode especially at high current rates, which should be due to the nanocrystalline structure of the TNO@NC inducing more contact interfaces between electrodes and electrolytes, and shortening the diffusion distance of Li⁺ in the bulk of the TNO.

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described below, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. § 112 (f) unless the words “means for” or “step for” are explicitly used in the particular claim. The above-described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method of making an electrode material, comprising the steps of:
(a) milling Nb₂O₅ powder to generate Nb₂O₅ nanoparticles of a first particle size;
(b) adding an oxidant to the Nb₂O₅ nanoparticles to form oxidant coated Nb₂O₅ nanoparticles;
(c) placing the oxidant coated Nb₂O₅ nanoparticles in a container with a carbon compound that releases a carbon compound vapor and sealing the container so that the oxidant causes the carbon compound vapor to polymerize on the Nb₂O₅ nanoparticles and so that the Nb₂O₅ nanoparticles agglomerate to form polymerized Nb₂O₅ nanoparticles of a second particle size;
(d) calcinating the polymerized Nb₂O₅ nanoparticles at a predetermined temperature so as to form a hierarchical N-rich carbon conductive electrode layer.

2. The method of claim 1, wherein the milling step comprises the step of high-energy ball milling (HEBM).

3. The method of claim 2, wherein the step of high-energy ball milling, comprises the steps of:
(a) placing the Nb₂O₅ powder and deionized water into a milling vessel in an HEBM machine;
(b) placing a plurality of grinding bowls in the milling vessel; and
(c) rotating the milling vessel at about 500 rpm for about 4 hours.

4. The method of claim 1, wherein the first particle size is about 30 nm.

5. The method of claim 1, wherein the step of adding an oxidant includes ultra-sonically dispersing the Nb₂O₅ nanoparticles with the oxidant.

6. The method of claim 1, wherein the oxidant comprises Fe³⁺ ions.

7. The method of claim 6, wherein the oxidant comprises a p-toluenesulfonate n-butanol solution.

8. The method of claim 6, further comprising the step of centrifuging the polymerized Nb₂O₅ nanoparticles with an organic solvent after the step of placing the oxidant coated Nb₂O₅ nanoparticles in a container with a carbon compound to remove excess oxidant or carbon compound monomers.

9. The method of claim 8, wherein the organic solvent comprises ethanol.

10. The method of claim 1, wherein the carbon compound comprises pyrrole

11. The method of claim 10, wherein the carbon compound is polymerized to form polypyrrole.

12. The method of claim 1, wherein the hierarchical N-rich carbon conductive layer comprises a TNO structure.

13. The method of claim 1, wherein the second particle size is in a range of about 200 nm to 300 nm.

14. The method of claim 1, wherein the predetermined temperature during the calcinating step is in a range of between 600° C. and 1000° C.

15. The method of claim 1, wherein the hierarchical N-rich carbon conductive electrode layer comprises Ti₂Nb₁₀O₂₉@NC (TNO@NC).

16. The method of claim 1, further comprising the step of grinding the polymerized Nb₂O₅ nanoparticles prior to the calcinating step.

17. The method of claim 16, wherein the grinding step comprises adding a stoichiometric amount of a metatitanic acid to the polymerized Nb₂O₅ nanoparticles.

18. An electrode, comprising:
(a) a conductive substrate; and
(b) a Ti₂Nb₁₀O₂₉@NC layer applied thereto.

19. The electrode of claim 18, wherein the conductive substrate comprises copper.

20. A battery, including:
(a) an anode;
(b) a cathode that includes a Ti₂Nb₁₀O₂₉ NC layer, and
(c) an electrolyte disposed between and in electrical communication with both the anode and the cathode.
